(19) United States
(12) Patent Application Publication
(10) Pub. No.: US 2022/0292885 A1
(43) Pub. Date: Sep. 15, 2022

(54) DRIVING DIAGNOSTIC DEVICE AND DRIVING DIAGNOSTIC METHOD

(71) Applicant: TOYOTA JIDOSHA KABUSHIKI KAISHA, Aichi-ken (JP)

(72) Inventor: Shuhei MANABE, Toyota-shi (JP)

(21) Appl. No.: 17/665,599

(22) Filed: Feb. 7, 2022

(30) Foreign Application Priority Data
Mar. 10, 2021 (JP) 2021-038779

(51) Int. Cl. G07C 5/00; G07C 5/02; G07C 5/08

(52) U.S. Cl. CPC G07C 5/008; G07C 5/02; G07C 5/085

(57) ABSTRACT

A driving diagnostic device includes a diagnosis result generation unit and a database unit. The diagnosis result generation unit generates a driving diagnosis result that is a diagnosis result regarding a driving operation of a vehicle based on a detection value that is a physical quantity that changes based on at least one of traveling, steering, and braking of the vehicle or a physical quantity that changes when a predetermined operating member is operated, and that is detected by a detection unit provided in the vehicle. The database unit records the driving diagnosis result, connection to the database unit being able to be established via the Internet.

### CROSS-REFERENCE TO RELATED APPLICATION

This application claims priority to Japanese Patent Application No. 2021-038779 filed on Mar. 10, 2021, incorporated herein by reference in its entirety.

### BACKGROUND

### 1. Technical Field

The present disclosure relates to a driving diagnostic device and a driving diagnostic method.

### 2. Description of Related Art

The following Japanese Patent No. 3593502 (JP 3593502 B) and Japanese Patent No. 6648304 (JP 6648304 B) disclose a system for acquiring a driving diagnosis result by using a detection value that is a physical quantity that changes based on at least one of traveling, steering, and braking of a vehicle.

### SUMMARY

An application for displaying a driving diagnosis result on a display is generally created by a manufacturer of a vehicle. However, if a person (organization) other than the manufacturer can create such an application, development of the application will be promoted.

In consideration of the above fact, an object of the present disclosure is to obtain a driving diagnostic device and a driving diagnostic method capable of promoting the development of an application for displaying a driving diagnosis result.

A driving diagnostic device according to claim 1 includes a diagnosis result generation unit and a database unit. The diagnosis result generation unit generates a driving diagnosis result that is a diagnosis result regarding a driving operation of a vehicle based on a detection value that is a physical quantity that changes based on at least one of traveling, steering, and braking of the vehicle or a physical quantity that changes when a predetermined operating member is operated, and that is detected by a detection unit provided in the vehicle. The database unit records the driving diagnosis result and connection to the database unit is able to be established via the Internet.

In the driving diagnostic device according to claim 1, connection to the database unit that records the driving diagnosis result is able to be established via the Internet. Therefore, a person who develops an application for displaying the driving diagnosis result can access the database unit via the Internet. Therefore, development of such an application is able to be promoted.

In the driving diagnostic device of the disclosure according to claim 2, in the disclosure according to claim 1, the driving diagnosis result includes a driving operation score calculated based on a Key Performance Indicator (KPI) acquired based on the detection value.

With the disclosure according to claim 2, a person who develops an application for displaying the driving diagnosis result including the driving operation score calculated based on the KPI is able to access the database unit via the Internet. Therefore, development of such an application is able to be promoted.

In the driving diagnostic device of the disclosure according to claim 3, in the disclosure according to claim 1 or claim 2, the driving diagnosis result includes an event that is a specific behavior of the vehicle and that is specified based on the detection value.

In the disclosure according to claim 3, a person who develops an application for displaying the driving diagnosis result including the event that is the specific behavior of the vehicle and that is specified based on the detection value is able to access the database unit via the Internet. Therefore, development of such an application is able to be promoted.

A driving diagnostic method of the disclosure according to claim 4 includes the steps of: recording, in a database unit, a diagnosis result generation unit that generates a driving diagnosis result that is a diagnosis result regarding a driving operation of a vehicle based on a detection value that is a physical quantity that changes based on at least one of traveling, steering, and braking of the vehicle or a physical quantity that changes when a predetermined operating member is operated, and that is detected by a detection unit provided in the vehicle; and allowing access to the database unit via the Internet.

As described above, the driving diagnostic device and the driving diagnostic method according to the present disclosure have an excellent effect that enables the development of the application for displaying the driving diagnosis result to be promoted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a vehicle capable of transmitting a detection value to a driving diagnostic device according to an embodiment;

FIG. 2 is a diagram showing the driving diagnostic device, a vehicle, and a mobile terminal according to the embodiment;

FIG. 3 is a control block diagram of a first server of the driving diagnostic device shown in FIG. 2;

FIG. 4 is a functional block diagram of a second server shown in FIG. 3;

FIG. 5 is a control block diagram of a third server of the driving diagnostic device shown in FIG. 2;

FIG. 6 is a control block diagram of a fourth server of the driving diagnostic device shown in FIG. 2;

FIG. 7 is a functional block diagram of the mobile terminal shown in FIG. 2;

FIG. 8 is a diagram showing a scene list;

FIG. 9 is a diagram showing an event list;

FIG. 10 is a flowchart showing a process executed by the second server;

FIG. 11 is a flowchart showing a process executed by the fourth server;

FIG. 12 is a flowchart showing a process executed by the mobile terminal shown in FIG. 2;

FIG. 13 is a diagram showing an image displayed on a display unit of the mobile terminal; and

FIG. 14 is a diagram showing an image displayed on the display unit of the mobile terminal.

### DETAILED DESCRIPTION OF EMBODIMENTS

Hereinafter, an embodiment of a driving diagnostic device 10 and a driving diagnostic method according to the present disclosure will be described with reference to the drawings.

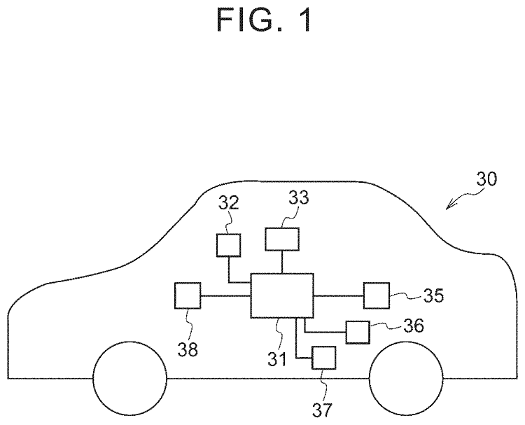

A vehicle 30 that enables data communication with the driving diagnostic device 10 via a network includes an electronic control unit (ECU) 31, a wheel speed sensor 32, an accelerator operation amount sensor 33, a steering angle sensor 35, a camera 36, a global positioning system (GPS) receiver 37, and a wireless communication device (detection value acquisition unit) 38, as shown in FIG. 1. A vehicle identification (ID) is attached to the vehicle 30 capable of receiving diagnosis by the driving diagnostic device 10. In the present embodiment, at least one vehicle 30 capable of receiving the diagnosis by the driving diagnostic device 10 is manufactured by a subject A. The wheel speed sensor 32, the accelerator operation amount sensor 33, the steering angle sensor 35, the camera 36, the GPS receiver 37, and the wireless communication device 38 are connected to the ECU 31. The ECU 31 includes a central processing unit (CPU), a read-only memory (ROM), a random access memory (RAM,) storage, a communication interface (communication I/F), and an input-output interface (input-output I/F). The CPU, the ROM, the RAM, the storage, the communication I/F, and the input-output I/F of the ECU 31 are connected to each other so as to be able to communicate with each other via a bus. The above network includes a communication network of a telecommunications carrier and an Internet network. The wireless communication device 38 of the vehicle 30 and a mobile terminal 50 described below perform data communication via the network.

The wheel speed sensor 32 (detection unit), the accelerator operation amount sensor 33 (detection unit), the steering angle sensor 35 (detection unit), and the GPS receiver 37 (detection unit) repeatedly detect, every time a predetermined time elapses, a physical quantity that changes based on at least one of traveling, steering, and braking of the vehicle 30 or a physical quantity that changes when a predetermined operating member (for example, a shift lever) is operated. The vehicle 30 is provided with four wheel speed sensors 32. Each wheel speed sensor 32 detects the wheel speed of each of the four wheels of the vehicle 30. The accelerator operation amount sensor 33 detects the accelerator operation amount. The steering angle sensor 35 detects the steering angle of a steering wheel. The GPS receiver 37 acquires information on a position where the vehicle 30 is traveling (hereinafter, referred to as “position information”) by receiving a GPS signal transmitted from a GPS satellite. The detection values detected by the wheel speed sensor 32, the accelerator operation amount sensor 33, the steering angle sensor 35, and the GPS receiver 37 are transmitted to the ECU 31 via a controller area network (CAN) provided in the vehicle 30 and stored in the storage of the ECU 31. Further, the camera 36 repeatedly captures a subject located outside of the vehicle 30 every time a predetermined time elapses. The image data acquired by the camera 36 is transmitted to the ECU 31 via the network provided in the vehicle 30 and stored in the storage.

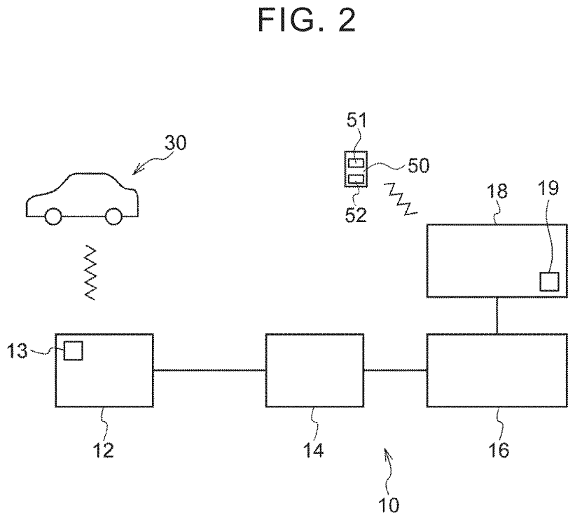

As shown in FIG. 2, the driving diagnostic device 10 includes a first server 12, a second server 14, a third server (database unit) 16, and a fourth server 18. For example, the first server 12, the second server 14, the third server 16, and the fourth server 18 are disposed in one building. The first server 12 and the fourth server 18 are connected to the above network. The first server 12 and the second server 14 are connected by a local area network (LAN). The second server 14 and the third server 16 are connected by the LAN. The third server 16 and the fourth server 18 are connected by the LAN. That is, the driving diagnostic device 10 is constructed as a cloud computing system. In the present embodiment, the first server 12, the second server 14, and the third server 16 are managed by the subject A. On the other hand, the fourth server 18 is managed by a subject B.

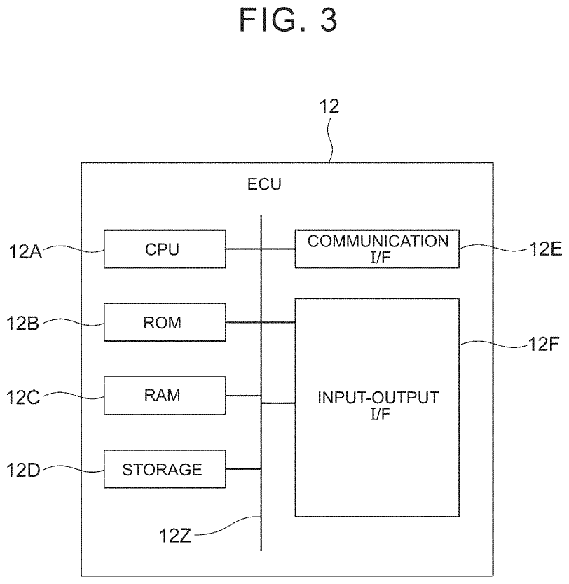

As shown in FIG. 3, the first server 12 includes a central processing unit (CPU: processor) 12A, a ROM 12B, a RAM 12C, storage (detection value recording unit) 12D, a communication I/F 12E, and an input-output I/F 12F. The CPU 12A, the ROM 12B, the RAM 12C, the storage 12D, the communication I/F 12E, and the input-output I/F 12F are connected to each other so as to be able to communicate with each other via a bus 12Z. The first server 12 can acquire information on date and time from a timer (not shown).

The CPU 12A is a central arithmetic processing unit that executes various programs and controls each unit. That is, the CPU 12A reads the program from the ROM 12B or the storage 12D, and executes the program using the RAM 12C as a work area. The CPU 12A controls each of the above components and performs various arithmetic processes (information processing) in accordance with the program recorded in the ROM 12B or the storage 12D.

The ROM 12B stores various programs and various data. The RAM 12C temporarily stores a program or data as a work area. The storage 12D is composed of a storage device such as a hard disk drive (HDD) or a solid state drive (SSD), and stores various programs and various data. The communication I/F 12E is an interface for the first server 12 to communicate with other devices. The input-output I/F 12F is an interface for communicating with various devices.

The detection value data representing the detection value detected by the wheel speed sensor 32, the accelerator operation amount sensor 33, the steering angle sensor 35, and the GPS receiver 37 of the vehicle 30, and the image data acquired by the camera 36 are transmitted from the wireless communication device 38 to a transmission-reception unit 13 of the first server 12 via the network every time a predetermined time elapses, and the detection value data and the image data are recorded in the storage 12D every time a predetermined time elapses. All the detection value data and the image data recorded in the storage 12D include information on the vehicle ID, information on the acquired time, and position information acquired by the GPS receiver 37.

The basic configurations of the second server 14, the third server 16, and the fourth server 18 are the same as those of the first server 12.

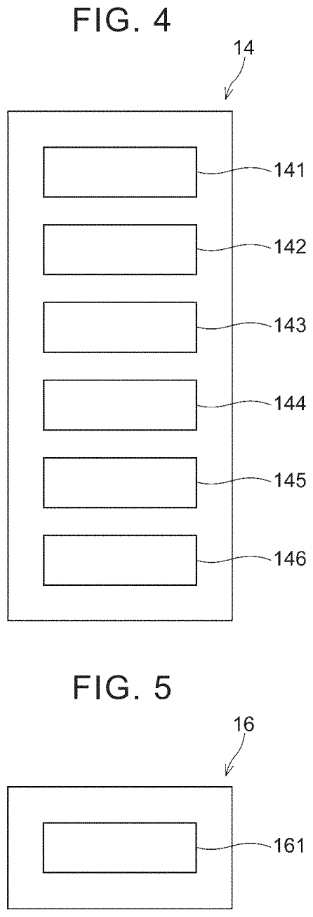

FIG. 4 shows an example of a functional configuration of the second server 14 as a block diagram. The second server 14 includes, as the functional configuration, a transmission-reception unit 141, a scene extraction unit (information extraction unit) 142, a key performance indicator (KPI) acquisition unit 143, a score calculation unit (diagnosis result generation unit) 144, and an event specification unit (information extraction unit) (diagnosis result generation unit) 145, and a deletion unit 146. The transmission-reception unit 141, the scene extraction unit 142, the KPI acquisition unit 143, the score calculation unit 144, the event specification unit 145, and the deletion unit 146 are realized as the CPU of the second server 14 reads and executes the program stored in the ROM.

The transmission-reception unit 141 transmits and receives information to and from the first server 12 and the third server 16 via the LAN. The detection value data and the image data recorded in the storage 12D of the first server 12 are transmitted to the transmission-reception unit 141 of the second server 14 while being associated with the vehicle ID. The detection value data and the image data transmitted from the first server 12 to the transmission-reception unit 141 include a data group acquired during a predetermined data detection time. This data detection time is, for example, 30 minutes. Hereinafter, the data group corresponding to one vehicle ID and acquired during the data detection time (detection value data and image data) will be referred to as a “detection value data group”. Detection value data groups recorded in the first server 12 are transmitted to the transmission-reception unit 141 in the order in which a detection value data group is acquired. More specifically, as described below, when a detection value data group is deleted from the storage of the second server 14, a newer detection value data group than the detection value data group is transmitted from the first server 12 to the transmission-reception unit 141, and the newer detection value data group is stored in the storage of the second server 14.

The scene extraction unit 142 identifies the detection value data group stored in the storage of the second server 14 into data representing a specific detection value and other data. More specifically, the scene extraction unit 142 processes data necessary for acquiring the KPI to be described below as the data representing the specific detection value.

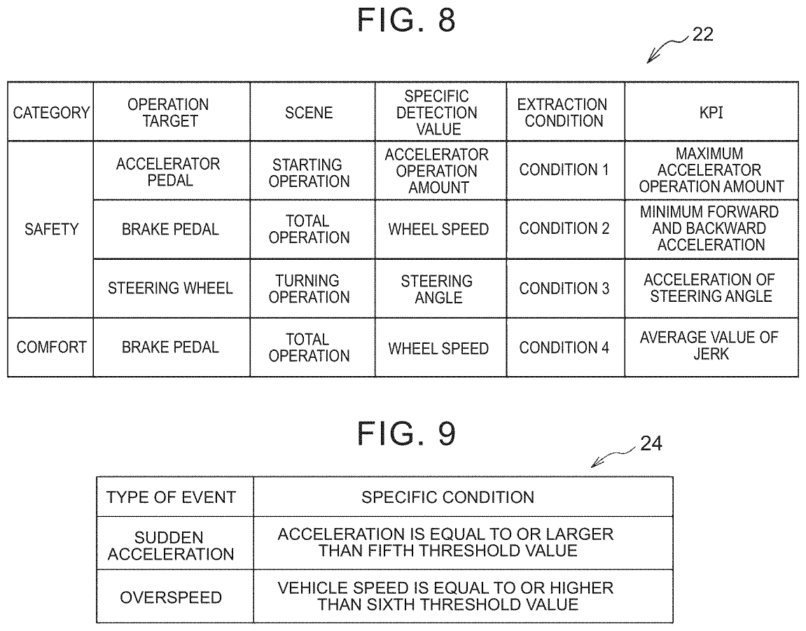

FIG. 8 is a scene list 22 recorded in the ROM of the second server 14. The scene list 22 is defined based on an operation target that is a member to be operated by a driver of the vehicle 30, an operation content of the operation target, and the like. The categories that are the largest items in the scene list 22 are “safety” and “comfort”. Further, the operation targets included in the category “safety” are an accelerator pedal, a brake pedal and a steering wheel. The operation target included in the category “comfort” is the brake pedal. Scenes, specific detection values, and extraction conditions are specified for each operation target.

For example, when the accelerator pedal included in the category “safety” is operated under a condition that a condition 1 is satisfied, the scene extraction unit 142 refers to the scene list 22 and determines that “a staring operation is performed using the accelerator pedal.” The condition 1 is, for example, a condition that the vehicle speed of the vehicle 30 is equal to or higher than a predetermined first threshold value. The vehicle speed of the vehicle 30 is calculated by the scene extraction unit 142 based on the wheel speed that is included in the detection value data group stored in the storage of the second server 14 and that is detected by each wheel speed sensor 32. Further, the scene extraction unit 142 determines whether the condition 1 is satisfied based on the calculated vehicle speed and the first threshold value. When the scene extraction unit 142 determines that the condition 1 is satisfied, the scene extraction unit 142 extracts, as the data representing the specific detection value, data related to the accelerator operation amount detected by the accelerator operation amount sensor 33 in the time zone when the condition 1 is satisfied from among the detection value data group stored in the storage.

For example, when the brake pedal included in the category “safety” is operated under a condition that a condition 2 is satisfied, the scene extraction unit 142 refers to the scene list 22 and determines that “a total operation is performed using the brake pedal.” The condition 2 is, for example, a condition that the vehicle speed of the vehicle 30 is equal to or higher than a predetermined second threshold value. The scene extraction unit 142 determines whether the condition 2 is satisfied based on the calculated vehicle speed and the second threshold value. When the scene extraction unit 142 determines that the condition 2 is satisfied, the scene extraction unit 142 extracts, as the data representing the specific detection value, data related to the wheel speed detected by the wheel speed sensor 32 in the time zone when the condition 2 is satisfied from among the detection value data group stored in the storage.

When the steering wheel included in the category “safety” is operated under a condition that a condition 3 is satisfied, the scene extraction unit 142 refers to the scene list 22 and determines that “a turning operation is performed using the steering wheel”. The condition 3 is, for example, a condition that the steering angle (steering amount) of the steering wheel within a predetermined time is equal to or greater than a predetermined third threshold value. The scene extraction unit 142 determines whether the condition 3 is satisfied based on information on the steering angle that is included in the detection value data group stored in the storage of the second server 14 and that is detected by the steering angle sensor 35, and the third threshold value. When the scene extraction unit 142 determines that the condition 3 is satisfied, the scene extraction unit 142 extracts, as the data representing the specific detection value, data related to the steering angle detected by the steering angle sensor 35 in the time zone when the condition 3 is satisfied from among the detection value data group stored in the storage.

For example, when the brake pedal included in the category “comfort” is operated under a condition that a condition 4 is satisfied, the scene extraction unit 142 refers to the scene list 22 and determines that “a total operation is performed using the brake pedal.” The condition 4 is, for example, a condition that the vehicle speed of the vehicle 30 is equal to or higher than a predetermined fourth threshold value. The scene extraction unit 142 determines whether the condition 4 is satisfied based on the calculated vehicle speed and the fourth threshold value. When the scene extraction unit 142 determines that the condition 4 is satisfied, the scene extraction unit 142 extracts, as the data representing the specific detection value, data related to the wheel speed detected by the wheel speed sensor 32 in the time zone when the condition 4 is satisfied from among the detection value data group stored in the storage.

When any of the extraction conditions is satisfied, the KPI acquisition unit 143 acquires (calculates) the KPI corresponding to the satisfied extraction condition.

For example, when the condition 1 is satisfied, the KPI acquisition unit 143 acquires the maximum accelerator operation amount in the time zone when the condition 1 is satisfied as the KPI from among the data (specific detection value) regarding the accelerator operation amount acquired by the scene extraction unit 142.

When the condition 2 is satisfied, the KPI acquisition unit 143 calculates the minimum forward and backward acceleration of the vehicle 30 in the time zone when the condition 2 is satisfied as the KPI based on the data (specific detection value) related to the wheel speed acquired by the scene extraction unit 142. That is, the KPI acquisition unit 143 acquires a calculated value (derivative value) using the wheel speed as the KPI.

When the condition 3 is satisfied, the KPI acquisition unit 143 calculates the acceleration of the steering angle in the time zone when the condition 3 is satisfied as the KPI based on the data (specific detection value) related to the steering angle acquired by the scene extraction unit 142. That is, the KPI acquisition unit 143 acquires a calculated value (second order derivative value) using the steering angle as the KPI.

When the condition 4 is satisfied, the KPI acquisition unit 143 calculates an average value of the forward and backward acceleration (jerk) of the vehicle 30 in the time zone when the condition 4 is satisfied as the KPI based on the data (specific detection value) related to the wheel speed acquired by the scene extraction unit 142. That is, the KPI acquisition unit 143 acquires a calculated value (second order derivative value) using the wheel speed as the KPI.

As will be described below, the score calculation unit 144 calculates a safety score, a comfort score, and a driving operation score based on the calculated KPI.

The event specification unit 145 specifies an event by referring to the detection value data group stored in the storage of the second server 14 and the event list 24 shown in FIG. 9 and recorded in the ROM of the second server 14. The event is a specific behavior of the vehicle 30 due to an operation by the driver. In the event list 24, a type (content) of the event and conditions (specific conditions) for being specified as an event are defined. In the event list 24, “sudden acceleration” and “overspeed” are defined as events.

The event specification unit 145 determines whether the vehicle 30 generates an acceleration equal to or higher than a predetermined fifth threshold value based on data on all wheel speeds included in the detection value data group stored in the storage. When the event specification unit 145 determines that the vehicle 30 has traveled at an acceleration equal to or higher than the fifth threshold value, the event specification unit 145 specifies, as events, the acceleration equal to or higher than the fifth threshold value, the date and time when the acceleration is generated, and the position information where the acceleration is generated.

The event specification unit 145 determines whether the vehicle 30 has traveled at a vehicle speed equal to or higher than a predetermined sixth threshold value based on data related to all wheel speeds included in the detection value data group stored in the storage. When the event specification unit 145 determines that the vehicle 30 has traveled at a vehicle speed equal to or higher than the sixth threshold value, the event specification unit 145 specifies, as events, the vehicle speed equal to or higher than the sixth threshold value, the date and time when the vehicle speed is generated, and the position information where the vehicle speed is generated.

When the scene extraction unit 142, the KPI acquisition unit 143, and the score calculation unit 144 complete the above process for one detection value data group recorded in the storage, the transmission-reception unit 141 transmits, to the third server 16, the data related to the safety score, the comfort score, and the driving operation score, which have been acquired, and the specified event, with the information on the vehicle ID. The data related to this event includes information regarding the date and time when each of the specified events occurred, the position information, and the image data acquired by the camera 36 within a predetermined time including the time when the event occurred.

When the scene extraction unit 142, the KPI acquisition unit 143, and the score calculation unit 144 complete the above process for one detection value data group, the deletion unit 146 deletes the detection value data group from the storage of the second server 14.

The third server 16 receives data related to the safety score, the comfort score, the driving operation score, and the specified event transmitted from the second server 14. As shown in FIG. 5, the third server 16 includes a transmission-reception unit 161 as a functional configuration. The transmission-reception unit 161 is realized as the CPU of the third server 16 reads and executes the program stored in the ROM. These data received by the transmission-reception unit 161 are recorded in the storage of the third server 16. The data regarding the safety score, the comfort score, the driving operation score, and the specified event are sequentially transmitted from the second server 14 to the third server 16, and the third server 16 records all the received data in the storage.

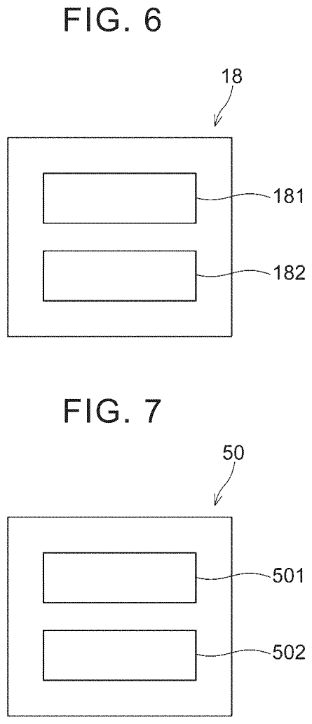

The fourth server 18 functions as at least the web server and the web application (WebApp) server. As shown in FIG. 6, the fourth server 18 includes a transmission-reception control unit 181 and a data generation unit 182 as a functional configuration. The transmission-reception control unit 181 and the data generation unit 182 are realized as the CPU of the fourth server 18 reads and executes the program stored in the ROM. The transmission-reception control unit 181 controls a transmission-reception unit 19 of the fourth server 18.

An operation terminal 50 shown in FIG. 2 includes a CPU, a ROM, a RAM, storage, a communication I/F, and an input-output I/F. The mobile terminal 50 is, for example, a smartphone or a tablet computer. The CPU, the ROM, the RAM, the storage, the communication I/F, and the input-output I/F of the operation terminal 50 are connected to each other so as to be able to communicate with each other via a bus. The operation terminal 50 can acquire information on date and time from a timer (not shown). The operation terminal 50 is provided with a display unit 51 including a touch panel. The display unit 51 is connected to the input-output I/F of the operation terminal 50. Further, map data is recorded in the storage of the mobile terminal 50. The operation terminal 50 includes a transmission-reception unit 52.

FIG. 7 shows an example of a functional configuration of the operation terminal 50 as a block diagram. The operation terminal 50 includes a transmission-reception control unit 501 and a display unit control unit 502 as a functional configuration. The transmission-reception control unit 501 and the display unit control unit 502 are realized as the CPU reads and executes the program stored in the ROM. The operation terminal 50 is owned by, for example, the driver of the vehicle 30 to which the vehicle ID is attached. A predetermined driving diagnosis display application is installed on the mobile terminal 50.

The transmission-reception unit 52 controlled by the transmission-reception control unit 501 transmits and receives data to and from the transmission-reception unit 19 of the fourth server 18.

The display unit control unit 502 controls the display unit 51. That is, the display unit control unit 502 causes the display unit 51 to display, for example, information that the transmission-reception unit 52 has received from the transmission-reception unit 19 and information input using the touch panel. The information input using the touch panel of the display unit 51 can be transmitted by the transmission-reception unit 52 to the transmission-reception unit 19.

### Operations and Effects

Next, operations and effects of the present embodiment will be described.

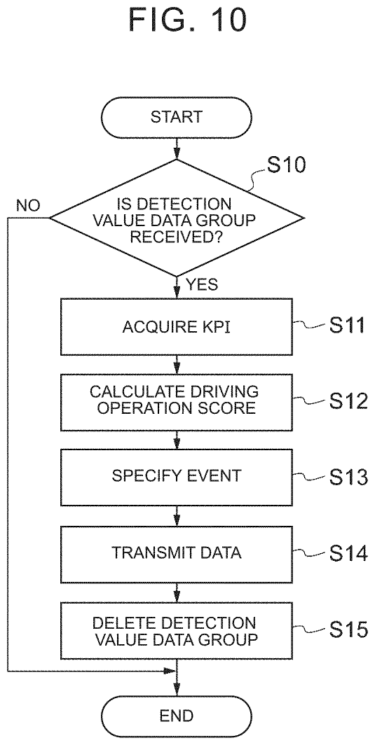

First, the flow of a process performed by the second server 14 will be described with reference to a flowchart of FIG. 10. The second server 14 repeatedly executes the process of the flowchart of FIG. 10 every time a predetermined time elapses.

First, in step S10, the transmission-reception unit 141 of the second server 14 determines whether the detection value data group has been received from the first server 12. In other words, the transmission-reception unit 141 determines whether the detection value data group is recorded in the storage of the second server 14.

When the determination result is Yes in step S10, the second server 14 proceeds to step S11, and the scene extraction unit 142 extracts data representing a specific detection value satisfying the extraction condition from among the detection value data group stored in the storage. Further, the KPI acquisition unit 143 acquires (calculates) each KPI based on the data representing the extracted specific detection value.

The second server 14 that has completed the process of step S11 proceeds to step S12, and the score calculation unit 144 calculates the safety score, the comfort score, and the driving operation score.

For example, in a case where the KPI acquired when the condition 1 of FIG. 8 is satisfied (maximum accelerator operation amount) is equal to or larger than a predetermined value, the score for this KPI is five points. On the other hand, when this KPI is less than a predetermined value, the score for this KPI is 100 points.

For example, in a case where the KPI acquired when the condition 2 of FIG. 8 is satisfied (minimum forward and backward acceleration) is less than a predetermined value, the score for this KPI is five points. On the other hand, when this KPI is equal to or larger than a predetermined value, the score for this KPI is 100 points.

For example, in a case where the KPI acquired when the condition 3 of FIG. 8 (acceleration of steering angle) is satisfied is equal to or larger than a predetermined value, the score for this KPI is five points. On the other hand, when this KPI is less than a predetermined value, the score for this KPI is 100 points.

A value obtained by dividing the total score of each KPI corresponding to each of the conditions 1 to 3 by the number of items (three) in the category “safety” (average value) is a safety score.

For example, in a case where the KPI acquired when the condition 4 of FIG. 8 is satisfied (average value of jerk) is equal to or larger than a predetermined value, the score for this KPI is five points. On the other hand, when this KPI is less than a predetermined value, the score for this KPI is 100 points.

A value obtained by dividing the total score of the KPI in the category “comfort” by the number of items in the category “comfort” (average value) is the comfort score. However, in the present embodiment, since the number of items in the category “comfort” is “one”, the score related to the KPI corresponding to the condition 4 is the comfort score.

Further, the score calculation unit 144 calculates the driving operation score based on the calculated safety score and comfort score. Specifically, the score calculation unit 144 acquires the value obtained by dividing the total score of the safety score and the comfort score by the sum of the number of items of the safety score and the comfort score (four) (average value) as the driving operation score.

The second server 14 that has completed the process of step S12 proceeds to step S13, and the event specification unit 145 specifies an event based on the detection value data group stored in the storage of the second server 14.

The second server 14 that has completed the process of step S13 proceeds to step S14, and the transmission-reception unit 141 transmits, to the third server 16, data on the safety score, the comfort score, the driving operation score, and the specified event, with information regarding the vehicle ID.

The second server 14 that has completed the process of step S14 proceeds to step S15, and the deletion unit 146 deletes the detection value data group from the storage of the second server 14.

When the determination result is No in step S10 or when the process of step S15 is completed, the second server 14 temporarily ends the process of the flowchart of FIG. 10.

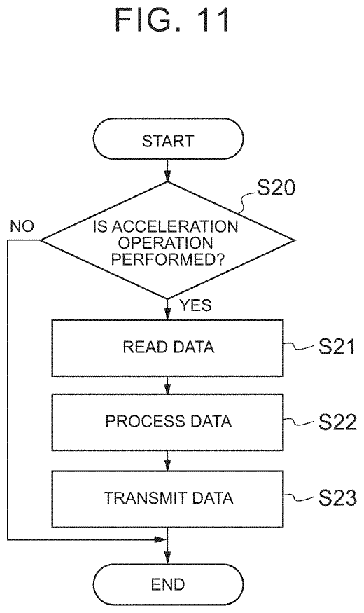

Next, the flow of a process performed by the fourth server 18 will be described with reference to a flowchart of FIG. 11. The fourth server 18 repeatedly executes the process of the flowchart of FIG. 11 every time a predetermined time elapses.

First, in step S20, the transmission-reception control unit 181 of the fourth server 18 determines whether a display request has been transmitted to the transmission-reception unit 19 from the transmission-reception control unit 501 (transmission-reception unit 52) of the mobile terminal 50 in which the driving diagnosis display application is activated. That is, the transmission-reception control unit 181 determines whether an access operation is performed from the mobile terminal 50. This display request includes information on the vehicle ID associated with the mobile terminal 50.

When the determination result is Yes in step S20, the fourth server 18 proceeds to step S21, and the transmission-reception control unit 181 (transmission-reception unit 19) communicates with the third server 16. The transmission-reception control unit 181 (transmission-reception unit 19) receives, from the transmission-reception unit 161 of the third server 16, data on the safety score, the comfort score, the driving operation score, and the specified event corresponding to the vehicle ID associated with the mobile terminal 50 that has transmitted the display request.

The fourth server 18 that has completed the process of step S21 proceeds to step S22, and the data generation unit 182 generates data representing a driving diagnosis result image 55 (see FIG. 13) using the data received in step S21. The driving diagnosis result image 55 can be displayed on the display unit 51 of the mobile terminal 50 in which the driving diagnosis display application is activated.

The fourth server 18 that has completed the process of step S22 proceeds to step S23, and the transmission-reception unit 19 transmits the data generated by the data generation unit 182 in step S22 to the transmission-reception control unit 501 (transmission-reception unit 52) of the mobile terminal 50.

When the determination result is No in step S20 or the process of step S23 is completed, the fourth server 18 temporarily ends the process of the flowchart of FIG. 11.

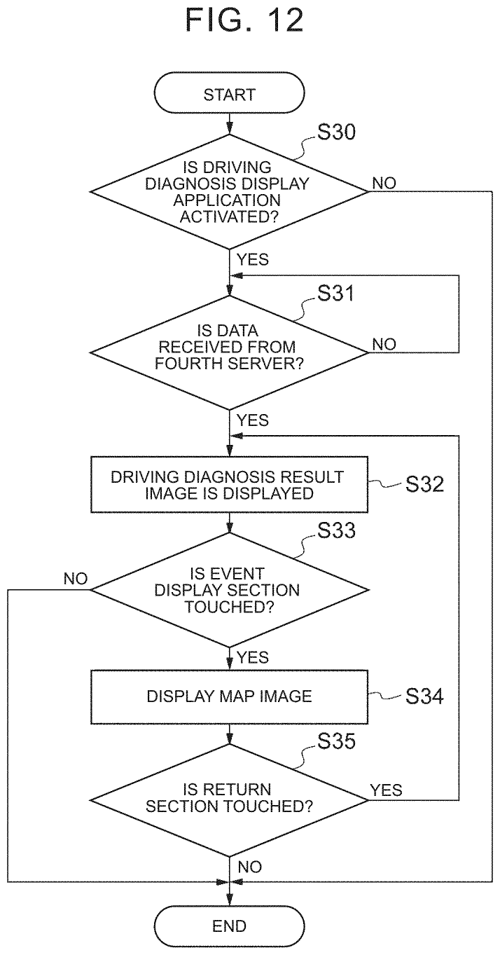

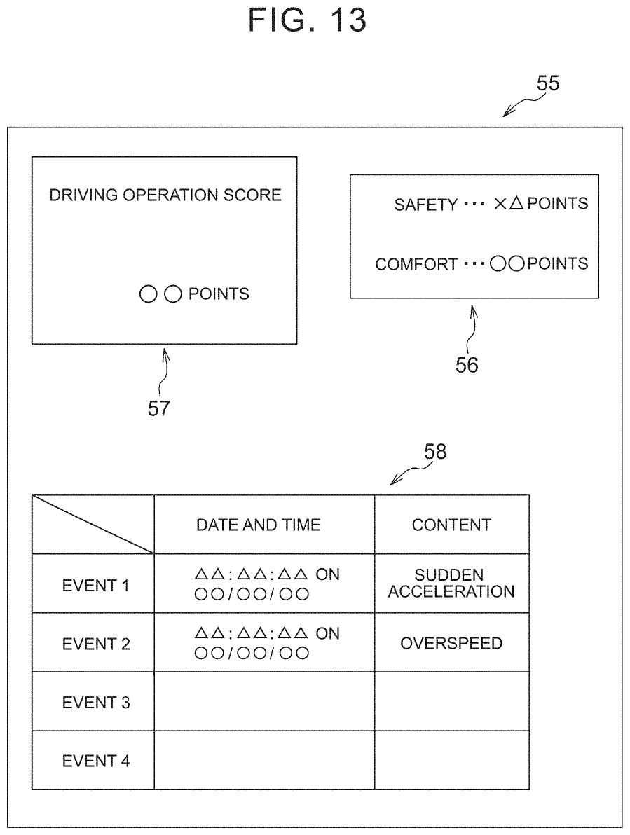

Next, the flow of a process performed by the mobile terminal 50 will be described with reference to a flowchart of FIG. 12. The mobile terminal 50 repeatedly executes the process of the flowchart of FIG. 12 every time a predetermined time elapses.

First, in step S30, the display unit control unit 502 of the mobile terminal 50 determines whether the driving diagnosis display application is activated.

When the determination result is Yes in step S30, the mobile terminal 50 proceeds to step S31, and determines whether the transmission-reception control unit 501 (transmission-reception unit 52) has received data representing the driving diagnosis result image 55 from the transmission-reception unit 19 of the fourth server 18.

When the determination result is Yes in step S31, the mobile terminal 50 proceeds to step S32, and the display unit control unit 502 causes the display unit 51 to display the driving diagnosis result image 55.

As shown in FIG. 13, the driving diagnosis result image 55 includes a safety and comfort display section 56, a score display section 57, and an event display section 58. The safety score and the comfort score are displayed on the safety and comfort display section 56. The driving operation score is displayed on the score display section 57. Information on each specified event is displayed on the event display section 58. The information representing each event includes date and time when the event occurred and contents thereof.

The mobile terminal 50 that has completed the process of step S32 proceeds to step S33, and the display unit control unit 502 determines whether the hand of the user of the mobile terminal 50 has touched the event display section 58 on the display unit 51 (touch panel).

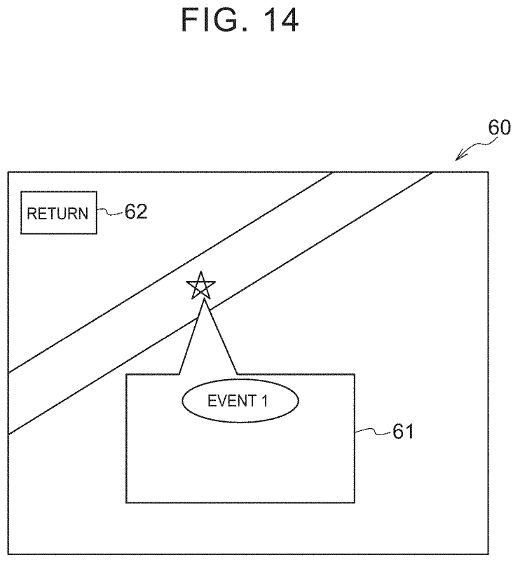

When the determination result is Yes in step S33, the mobile terminal 50 proceeds to step S34, and the display unit control unit 502 causes the display unit 51 to display a map image 60 based on the map data shown in FIG. 14. Here, it is assumed that the driver taps on “event 1” in the event display section 58. In this case, the map image 60 includes map information on a location where the event 1 occurred and surroundings thereof, and the location where the event 1 occurred is displayed as a star mark (⋆). Further, when the user taps on the star mark (⋆), an event image 61 representing the image data acquired by the camera 36 within a predetermined time including the time when the event 1 occurred is displayed. This predetermined time is, for example, 10 seconds.

The mobile terminal 50 that has completed the process of step S34 proceeds to step S35, and the display unit control unit 502 determines whether the hand of the user has touched a return section 62 on the map image 60. When the determination result is Yes in step S35, the display unit control unit 502 of the mobile terminal 50 proceeds to step S32, and causes the display unit 51 to display the driving diagnosis result image 55.

When the determination result is No in step S30, step S33 or step 35, the mobile terminal 50 temporarily ends the process of the flowchart of FIG. 12.

As described above, in the driving diagnostic device 10 and the driving diagnostic method according to the present embodiment, the KPI acquisition unit 143 calculates the KPI using only the specific detection value in the detection value data group. Therefore, the calculation load to the KPI acquisition unit 143 is small as compared with a case where calculation for the KPI is performed using all the data in the detection value data groups. Therefore, a calculation load in the driving diagnostic device 10 and the driving diagnostic method according to the present embodiment is small.

Further, the image data included in the data group to be transmitted from the second server 14 to the third server 16 is only the image data when the event occurred. Therefore, the amount of data accumulated in the storage of the third server 16 is small as compared with a case where all the image data recorded in the storage of the second server 14 are transmitted from the second server 14 to the third server 16.

Further, in the driving diagnostic device 10 and the driving diagnostic method according to the present embodiment, the driving diagnosis is performed using the driving operation score (KPI) and the event. Therefore, the driver who has seen the driving diagnosis result image 55 can recognize the characteristics of his/her driving operation from a wide range of viewpoints.

Further, in the driving diagnostic device 10 and the driving diagnostic method according to the present embodiment, the subject B that is different from the subject A that manages the first server 12, the second server 14, and the third server 16 and manufactures the vehicle can access the data stored in the third server 16. Therefore, a person (organization) different from the subject A can create an application (driving diagnosis display application) that uses the driving diagnosis result to be obtained by the driving diagnostic device 10 and the driving diagnostic method according to the present embodiment. Therefore, development of such an application can be promoted.

Although the driving diagnostic device 10 and the driving diagnostic method according to the embodiment have been described above, design of the driving diagnostic device 10 and the driving diagnostic method can be changed as appropriate without departing from the scope of the disclosure.

The category, the operation target, the scene, the specific detection value, the extraction condition, and the KPI shown in FIG. 8 are not limited to those shown in FIG. 8. For example, a plurality of the operation targets, the scenes, the specific detection values, the extraction conditions, and the KPIs in the category “comfort” may be shown.

The type of events shown in FIG. 9 is not limited to those shown in FIG. 9. For example, at least one of occurrence of abrupt steering wheel operation, activation of antilock brake system (ABS), activation of a pre-crash safety system (PCS), and detection of collision with an obstacle may be specified as an event.

The driving diagnostic device 10 may be realized as a configuration different from the above. For example, the first server 12, the second server 14, the third server 16, and the fourth server 18 may be realized by one server. In this case, for example, using a hypervisor, the inside of the server may be virtually partitioned into areas each corresponding to the first server 12, the second server 14, the third server 16, and the fourth server 18.

The detection unit that acquires the detection value data group may be any device as long as the detection unit acquires a physical quantity that changes based on at least one of traveling, steering, and braking of the vehicle, or a physical quantity that changes when a predetermined operating member is operated. For example, this detection unit may be a sensor for measuring a coolant temperature of an engine, a yaw rate sensor, a shift lever position sensor, or the like. Moreover, the number of the detection units may be any number.

The driving diagnostic device 10 may acquire only one of the driving operation score and the event. In this case, only one of the driving operation score and the event is accumulated in the storage of the third server 16.

The KPI acquisition (calculation) method and the calculation method for the driving operation score may be different from the above methods. For example, the safety score and the comfort score may be calculated while each KPI is weighted.

The third server 16 may have a function of confirming access rights when the third server 16 is accessed from the fourth server 18. In this case, only when the third server 16 confirms that the access rights are granted to the fourth server 18, the fourth server 18 can receive the data on the safety score, the comfort score, the driving operation score, and the specified event from the third server 16.

It is possible to restrict access by the subject B (fourth server 18) to part of the data recorded in the storage of the third server 16 to a certain degree. For example, information indicating access to the part of the data recorded in the storage of the third server 16 is to be restricted is added to the part of the data group recorded in the storage of the third server 16. Access by the subject B (fourth server 18) to the data to which the information indicating that the access is to be restricted is added is prohibited (even when the fourth server 18 has the access rights). The data to which information indicating restriction target is added is, for example, position information.

Instead of the GPS receiver 37, the vehicle 30 may include a receiver capable of receiving information from satellites of a global navigation satellite system (for example, Galileo) other than the GPS.

The mobile terminal 50 may read the map data from the Web server and display the map image on the display unit 51.

What is claimed is:

1. A driving diagnostic device comprising:
a diagnosis result generation unit that generates a driving diagnosis result that is a diagnosis result regarding a driving operation of a vehicle based on a detection value that is a physical quantity that changes based on at least one of traveling, steering, and braking of the vehicle or a physical quantity that changes when a predetermined operating member is operated, and that is detected by a detection unit provided in the vehicle; and
a database unit that records the driving diagnosis result, connection to the database unit being able to be established via the Internet.

2. The driving diagnostic device according to claim 1, wherein the driving diagnosis result includes a driving operation score calculated based on a Key Performance Indicator (KPI) acquired based on the detection value.

3. The driving diagnostic device according to claim 1, wherein the driving diagnosis result includes an event that is a specific behavior of the vehicle and that is specified based on the detection value.

4. A driving diagnostic method comprising the steps of:
recording, in a database unit, a diagnosis result generation unit that generates a driving diagnosis result that is a diagnosis result regarding a driving operation of a vehicle based on a detection value that is a physical quantity that changes based on at least one of traveling, steering, and braking of the vehicle or a physical quantity that changes when a predetermined operating member is operated, and that is detected by a detection unit provided in the vehicle; and
allowing access to the database unit via the Internet.
